(19) United States
(12) Patent Application Publication
(10) Pub. No.: US 2025/0211378 A1
(43) Pub. Date: Jun. 26, 2025

(54) OMITTING CHANNEL STATE INFORMATION FOR COHERENT JOINT TRANSMISSIONS

(71) Applicant: QUALCOMM Incorporated, San Diego, CA (US)

(72) Inventors: Chao WEI, Beijing (CN); Jing DAI, Beijing (CN); Chenxi HAO, Beijing (CN); Min HUANG, Beijing (CN); Liangming WU, Beijing (CN); Hao XU, Beijing (CN)

(21) Appl. No.: 18/848,082

(22) PCT Filed: May 20, 2022
(86) PCT No.: PCT/CN2022/094070

§ 371 Date: Sep. 17, 2024

(51) Int. Cl. H04L 5/00; H04B 7/024; H04W 24/10; H04W 72/21

(52) U.S. Cl. CPC H04L 5/0035; H04B 7/024; H04L 5/0057; H04W 24/10; H04W 72/21

(57) ABSTRACT

A method for wireless communication by a user equipment (UE) includes receiving a message scheduling a physical uplink shared channel (PUSCH). The method also includes determining that a quantity of resources allocated for channel state information (CSI) reporting via the PUSCH is insufficient for transmitting a CSI report for a coherent joint transmission (CJT) associated with transmit and receive points (TRPs). Each TRP may be associated with a set of CSI components. The method further includes prioritizing the CSI components based on a TRP priority rule. The method still further includes omitting one or more CSI components from the prioritized CSI components. The method also includes transmitting, to one or more TRPs, the CSI report comprising remaining CSI components based on omitting the one or more CSI components.

### FIELD OF THE DISCLOSURE

The present disclosure relates generally to wireless communications, and more specifically to channel state information (CSI) omission for coherent joint transmission (CJT) CSI.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

In some wireless communication systems, a user equipment (UE) may provide channel feedback, such as a channel state information (CSI) report, based on measuring one or more reference signals (RSs), such as CSI-RSs, transmitted by a network node. The CSI report may be transmitted via a physical uplink shared channel (PUSCH). In some examples, the CSI may be divided into two separately encoded parts. The first CSI part (e.g., CSI Part 1) may have a known payload size and the second CSI part (e.g., CSI Part 2) may have a variable payload size. Because the payload of a CSI Part 2 report may vary, the network node may be unaware of the payload size when allocating PUSCH resources. Thus, in some example, the PUSCH resource may be insufficient for a payload associated with a CSI Part 2 report. In such examples, the UE may omit one or more CSI components of the CSI Part 2 report, such that the allocated PUSCH resources may be sufficient for transmitting the CSI Part 2 report.

### SUMMARY

One aspect of the present disclosure is directed to a method for wireless communication at a user equipment (UE). The method includes receiving a message scheduling a physical uplink shared channel (PUSCH). The method also includes determining that a quantity of resources allocated for channel state information (CSI) reporting via the PUSCH is insufficient for transmitting a CSI report for a CJT associated with a group of TRPs. Each TRP of the group of TRPs may be associated with a set of CSI components from a number of CSI components of the CSI report. The method still further includes prioritizing the group of CSI components based on a TRP priority rule. The method also includes omitting one or more CSI components from the prioritized group of CSI components based on determining the quantity of resources is insufficient. The method further includes transmitting, to one or more TRPs, the CSI report comprising remaining CSI components of the group of CSI components based on omitting the one or more CSI components.

Another aspect of the present disclosure is directed to an apparatus including means for receiving a message scheduling a PUSCH. The apparatus further includes means for determining that a quantity of resources allocated for CSI reporting via the PUSCH is insufficient for transmitting a CSI report for a CJT associated with a group of TRPs. Each TRP of the group of TRPs may be associated with a set of CSI components from a number of CSI components of the CSI report. The apparatus still further includes means for prioritizing the group of CSI components based on a TRP priority rule. The apparatus also includes means for omitting one or more CSI components from the prioritized group of CSI components based on determining the quantity of resources is insufficient. The apparatus further includes means for transmitting, to one or more TRPs, the CSI report comprising remaining CSI components of the group of CSI components based on omitting the one or more CSI components.

In another aspect of the present disclosure, a non-transitory computer-readable medium with non-transitory program code recorded thereon is disclosed. The program code is executed by a processor and includes program code to receive a message scheduling a PUSCH. The program code further includes program code to determine that a quantity of resources allocated for CSI reporting via the PUSCH is insufficient for transmitting a CSI report for a CJT associated with a group of TRPs. Each TRP of the group of TRPs may be associated with a set of CSI components from a number of CSI components of the CSI report. The program code still further includes program code to prioritize the group of CSI components based on a TRP priority rule. The program code also includes program code to omit one or more CSI components from the prioritized group of CSI components based on determining the quantity of resources is insufficient. The program code further includes program code to transmit, to one or more TRPs, the CSI report comprising remaining CSI components of the group of CSI components based on omitting the one or more CSI components.

Another aspect of the present disclosure is directed to an apparatus for wireless communications at a UE. The apparatus includes a processor; and a memory coupled with the processor and storing instructions operable, when executed by the processor, to cause the apparatus to receive a message scheduling a PUSCH. Execution of the instructions also cause the apparatus to determine that a quantity of resources allocated for CSI reporting via the PUSCH is insufficient for transmitting a CSI report for a CJT associated with a group of TRPs. Each TRP of the group of TRPs may be associated with a set of CSI components from a number of CSI components of the CSI report. Execution of the instructions further cause the apparatus to prioritize the group of CSI components based on a TRP priority rule. Execution of the instructions also cause the apparatus to omit one or more CSI components from the prioritized group of CSI components based on determining the quantity of resources is insufficient. Execution of the instructions still further cause the apparatus to transmit, to one or more TRPs, the CSI report comprising remaining CSI components of the group of CSI components based on CSI components remaining in the CSI report.

In one aspect of the present disclosure, a method for wireless communication at a network node includes transmitting a message scheduling a PUSCH. The method further includes transmitting one or more CSI-RSs associated with a CJT for a group of TRPs, the network node is one TRP of the group of TRPs. The method still further includes receiving, from a UE, a CSI report based on transmitting the one or more CSI-RSs. Each TRP of the group of TRPs may be associated with a set of CSI components from a group of CSI components of the CSI report. The method also includes determining that a quantity of resources allocated for CSI reporting via the PUSCH was insufficient for the CSI report. The method further includes determining one or more CSI components from a prioritized group of CSI components were omitted from the CSI report based on determining the quantity of resources was insufficient, the group of CSI components being prioritized based on a TRP priority rule. The method still further includes transmitting a precoded message based on determining the one or more CSI components were omitted from the prioritized group of CSI components. The precoding may be determined based on CSI components remaining in the CSI report.

Another aspect of the present disclosure is directed to an apparatus including means for transmitting a message scheduling a PUSCH. The apparatus further includes means for transmitting one or more CSI-RSs associated with a CJT for a group of TRPs, the network node is one TRP of the group of TRPs. The apparatus still further includes means for receiving, from a UE, a CSI report based on transmitting the one or more CSI-RSs. Each TRP of the group of TRPs may be associated with a set of CSI components from a group of CSI components of the CSI report. The apparatus also includes means for determining that a quantity of resources allocated for CSI reporting via the PUSCH was insufficient for the CSI report. The apparatus further includes means for determining one or more CSI components from a prioritized group of CSI components were omitted from the CSI report based on determining the quantity of resources was insufficient, the group of CSI components being prioritized based on a TRP priority rule. The apparatus still further includes means for transmitting a precoded message based on determining the one or more CSI components were omitted from the prioritized group of CSI components. The precoding may be determined based on CSI components remaining in the CSI report.

In another aspect of the present disclosure, a non-transitory computer-readable medium with non-transitory program code recorded thereon is disclosed. The program code is executed by a processor and includes program code to transmit a message scheduling a PUSCH. The program code further includes program code to transmit one or more CSI-RSs associated with a CJT for a group of TRPs, the network node is one TRP of the group of TRPs. The program code still further includes program code to receive, from a UE, a CSI report based on transmitting the one or more CSI-RSs. Each TRP of the group of TRPs may be associated with a set of CSI components from a group of CSI components of the CSI report. The program code also includes program code to determine that a quantity of resources allocated for CSI reporting via the PUSCH was insufficient for the CSI report. The program code further includes program code to determine one or more CSI components from a prioritized group of CSI components were omitted from the CSI report based on determining the quantity of resources was insufficient, the group of CSI components being prioritized based on a TRP priority rule. The program code still further includes program code to transmit a precoded message based on determining the one or more CSI components were omitted from the prioritized group of CSI components. The precoding may be determined based on CSI components remaining in the CSI report.

Another aspect of the present disclosure is directed to an apparatus for wireless communications at a network node. The apparatus includes a processor; and a memory coupled with the processor and storing instructions operable, when executed by the processor, to cause the apparatus to transmit a message scheduling a PUSCH. Execution of the instructions also cause the apparatus to transmit one or more CSI-RSs associated with a CJT for a group of TRPs, the network node is one TRP of the group of TRPs. Execution of the instructions further cause the apparatus to receive, from a UE, a CSI report based on transmitting the one or more CSI-RSs. Each TRP of the group of TRPs may be associated with a set of CSI components from a group of CSI components of the CSI report. Execution of the instructions still further cause the apparatus to determine that a quantity of resources allocated for CSI reporting via the PUSCH was insufficient for the CSI report. Execution of the instructions also cause the apparatus to determine one or more CSI components from a prioritized group of CSI components were omitted from the CSI report based on determining the quantity of resources was insufficient, the group of CSI components being prioritized based on a TRP priority rule. Execution of the instructions further cause the apparatus to transmit a precoded message based on determining the one or more CSI components were omitted from the prioritized group of CSI components. The precoding may be determined based on CSI components remaining in the CSI report.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is block diagram illustrating an example of channel state information (CSI) omission groups.

FIG. 5 is a timing diagram illustrating an example of omitting one or more CSI components, in accordance with certain aspects of the present disclosure.

FIG. 6 is a block diagram illustrating an example of transmit and receive point (TRP) sets, in accordance with aspects of the present disclosure.

FIG. 7A is a block diagram illustrating an example of prioritizing non-zero coefficients (NZCs), in accordance with various aspects of the present disclosure.

FIG. 7B is a block diagram illustrating an example of grouping NZCs based on a priority level, in accordance with aspects of the present disclosure.

FIG. 8 is a flow diagram illustrating an example process performed, for example, by a user equipment (UE), in accordance with various aspects of the present disclosure.

FIG. 9 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In some wireless communication systems, a user equipment (UE) may provide channel feedback, such as a channel state information (CSI) report, based on measuring one or more reference signals (RSs), such as CSI-RSs, transmitted by a network node. The CSI report may be transmitted via a physical uplink shared channel (PUSCH). In some examples, the CSI may be divided into two separately encoded parts. The first CSI part (e.g., CSI Part 1) may have a known payload size and the second CSI part (e.g., CSI Part 2) may have a variable payload size. Because the payload of a CSI Part 2 report may vary, the network node may be unaware of the payload size when allocating PUSCH resources. Thus, in some examples, the PUSCH resource may be insufficient for a payload associated with a CSI Part 2 report. In such examples, the UE may omit one or more CSI components of the CSI Part 2 report, such that the allocated PUSCH resources may be sufficient for transmitting the CSI Part 2 report.

Conventional UEs may omit one or more CSI components based on a priority rule. Still, such conventional UEs may be limited to omitting CSI components associated with one transmit and receive point (TRP). In some examples, a UE may receive simultaneous transmissions from two or more TRPs. Simultaneous transmission from two or more TRPs may be an example of a joint transmission. The joint transmission may be a coherent joint transmission (CJT) if the network has information about the channel to the UE from the two or more TRPs associated with the joint transmission. In such examples, the network may select transmission weights based on the channel information to focus energy towards the position of the UE. Coherent joint transmission across multiple TRPs may improve coverage and increase throughput. Coverage and throughput may be further improved by improving backhaul communication and synchronization between the TRPs. Various aspects of the present disclosure are directed to omitting CSI components, such as Type II CSI or eType II CSI, associated with a coherent joint transmission (CJT).

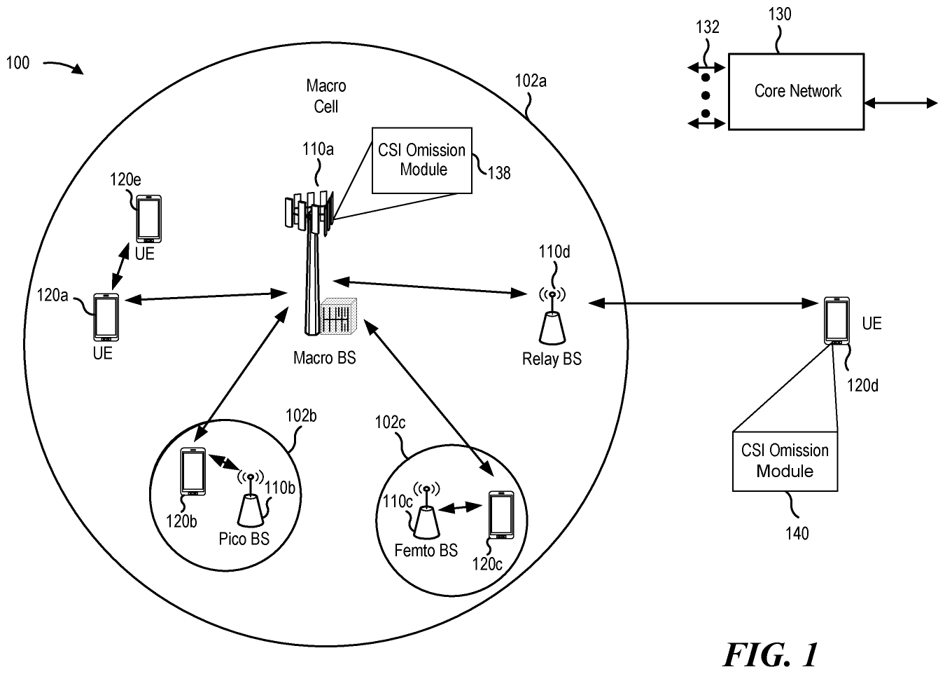

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

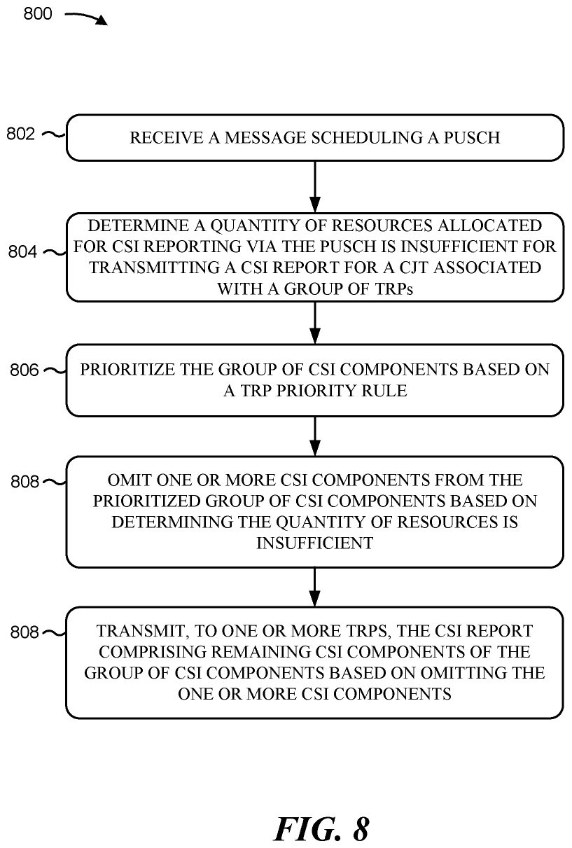

The UEs 120 may include a CSI omission module 140. For brevity, only one UE 120d is shown as including the CSI omission module 140. The CSI omission module 140 may be configured to perform one or more of the elements of the process 800 described with respect to FIG. 8.

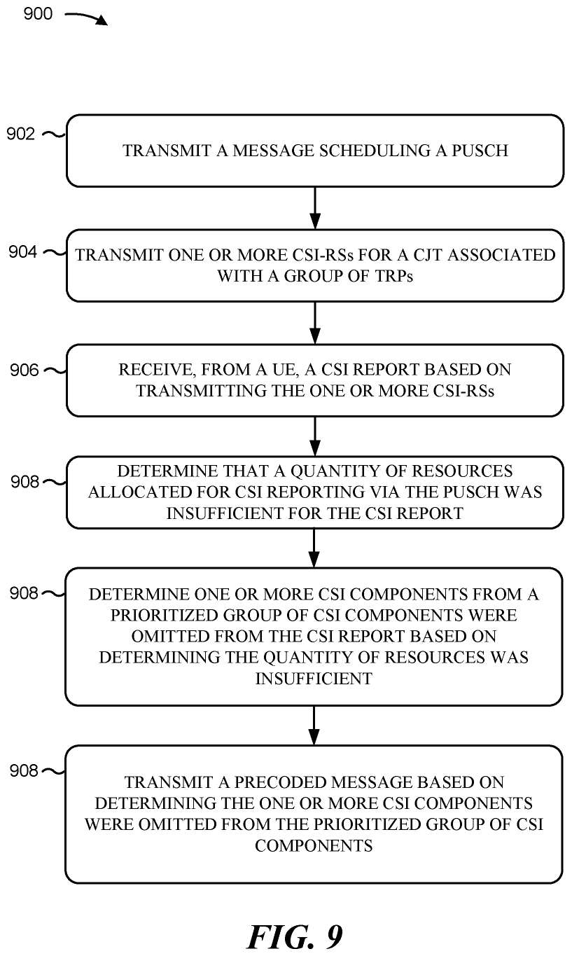

The core network 130 or the base stations 110 may include a CSI omission module 138 that may be be configured to perform one or more of the elements of the process 900 described with respect to FIG. 9.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

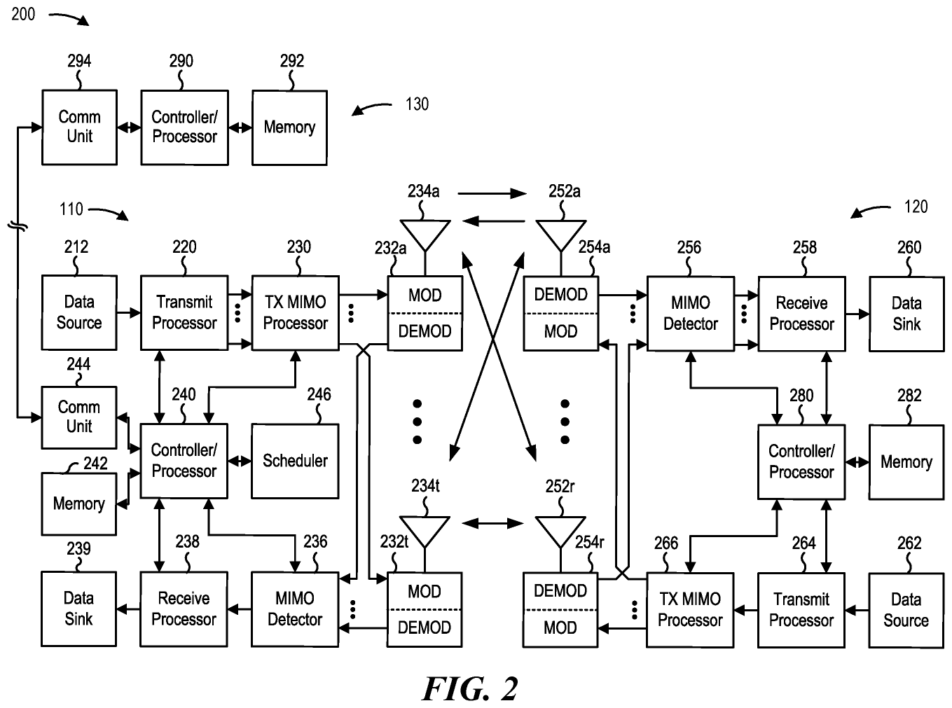

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with CSI omission, as described in more detail elsewhere. For example, the controller/processor 240 of the base station 110, the controller/processor 280 of the UE 120, and/or any other component(s) of FIG. 2 may perform or direct operations of, for example, the processes of FIGS. 8 and 9 and/or other processes as described. Memories 242 and 282 may store data and program codes for the base station 110 and UE 120, respectively. A scheduler 246 may schedule UEs for data transmission on the downlink and/or uplink.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

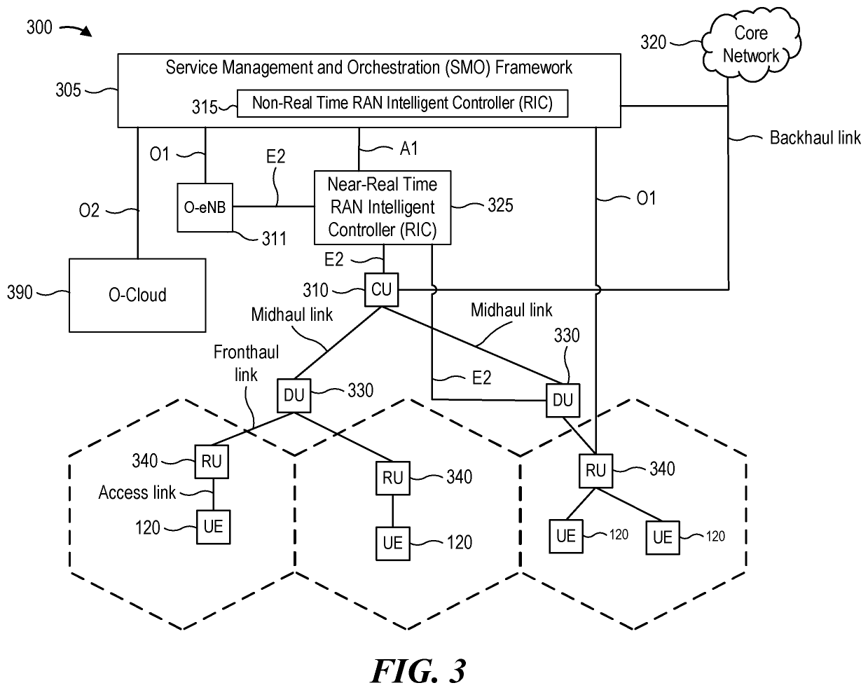

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via 01) or via creation of RAN management policies (such as A1 policies).

Some wireless communication systems, such as NR Release 16, specify overhead reduction mechanisms. Given the correlation between different phase coefficients for different subbands, the correlation may be used for compression to reduce a number of bits specified to represent information. In some examples, for eType II CSI, spatial domain (SD) and frequency domain (FD) compression may be specified based on a linear combination of discrete Fourier transform (DFT) bases. In such examples, the codebook for eType II CSI may be designed to use precoders for a layer l across N₃ precoder matrix indicator (PMI) subbands. The precoders may have a size-Nₜ×N₃ matrix W^{(l)=W}₁\tilde{W}_{2,l}W_{f,l}^{H}. In this example, the parameter Nₜ represents a number of SD dimensions (e.g., a quantity of antenna ports) and N₃ represents a quantity of FD dimensions (e.g., a quantity of PMI subbands). Additionally, the parameter W₁ represents an SD basis that may be layer-common, where a quantity of beams L may be configured via radio resource control (RRC) signaling. The parameter W_{f,l}^{H} represents an FD basis that may be layer-specific. For the FD basis, the UE may select M bases out of candidate N₃ bases. The UE may also report the selection for each layer. Furthermore, the parameter \tilde{W}_{2,l} represents coefficients. For each layer, the UE may report up to K₀ coefficients, where a value for K₀ is configured via RRC signaling. Furthermore, across all layers, the UE may report up to 2K₀ coefficients. The reported coefficients may be non-zero coefficients (NZCs). Unreported coefficients may be set to zero. The UE may report coefficient selection (e.g., the location of NZCs within \tilde{W}_{2,l}) and a quantization of the NZCs for each layer.

As discussed, various aspects of the present disclosure are directed to omitting CSI components, such as Type II CSI or eType II CSI, associated with coherent joint transmission (CJT) (e.g., coherent joint transmission Type II CSI). In some examples, a codebook structure for coherent joint transmission Type II CSI may specify joint FD compression across multiple TRPs. In such examples, a precoder for coherent joint transmission across two TRPs is given by

$$P = [ \begin{matrix}{P}_{1} \\ {P}_{2}\end{matrix} ] = [ \begin{matrix}{W}_{1 , 1} & 0 \\ 0 & {W}_{1 , 2}\end{matrix} ] {\tilde{W}}_{2} {W}_{f}^{H} ,$$

where the parameters W_{1,1} and W_{1,2} represent an SD compression matrix for a first TRP and a second TRP, respectively. In some other examples, the codebook structure for coherent joint transmission Type II CSI may specify FD compression for each TRP (e.g., per-TRP FD compression) and a co-amplitude/phase across the multiple TRPs. In such examples, a precoder for coherent joint transmission across two This is given by

$$P = [ \begin{matrix}{P}_{1} \\ {qP}_{2}\end{matrix} ] = [ \begin{matrix}{W}_{1 , 1} {\tilde{W}}_{2 , 1} {W}_{f , 1}^{H} \\ {γ}_{2} {W}_{1 , 2} {\tilde{W}}_{2 , 2} {W}_{f , 2}^{H}\end{matrix} ]$$

where the parameters P₁ and P₂ are TRP-specific Type II precoders, and the parameter γ₂ is an inter-TRP co-amplitude/phase (assuming) γ₁=1).

The CSI report associated with coherent joint transmission Type II CSI may include one or more CSI components. The one or more CSI components may include one or more of a TRP-specific or TRP-common SD basis, a TRP-specific or TRP-common FD basis, TRP-specific non-zero coefficients and associated selection bits (e.g., non-zero power selection bits), a strongest reference TRP indicator (STI), a reference inter-TRP co-amplitude for each non-reference TRP, and/or a reference amplitude for a weaker polarization for each TRP.

As discussed, in some wireless systems, when CSI reporting on PUSCH comprises two parts, the UE may omit a portion (e.g., one or more CSI components) of the Part 2 CSI when PUSCH resources are insufficient for the Part 2 CSI report (e.g., CSI payload). In some examples, one or more CSI components may be omitted based on a priority order where priority 0 is the highest priority

For some CSI reports, such as an eType II CSI report, CSI components are partitioned into groups and the groups are prioritized in descending order. That is, CSI parameters (e.g., UCI parameters), or individual bits of CSI parameters, in CSI Part 2 may be grouped into two or more CSI omission groups. Each group has a certain priority level and CSI parameters of the different groups are omitted according to the priority level of the group as part of the CSI omission procedure. The CSI parameters may also be referred to as CSI components.

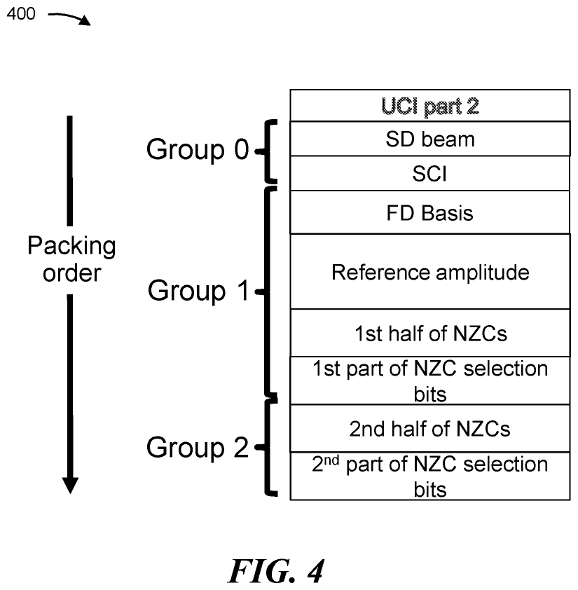

FIG. 4 is a block diagram illustrating an example 400 of CSI omission groups for a single TRP. In the example 400 of FIG. 4, a UE, such as the UE 120 described with reference to FIGS. 1, 2, and 3, may map CSI components to different CSI omission groups based on a priority rule. For ease of explanation, a CSI omission group may be referred to as a group. As shown in FIG. 4, a highest priority may be assigned to group 0, which may include an SD basis indication, such as an SD beam index, and strongest coefficient indices (SCIs). Additionally, as shown in FIG. 4, group 1 may include an FD basis indication, a reference amplitude for a weaker polarization, a first half of non-zero coefficients (NZCs), and a first part of NZC selection bits. The first half of the NZCs may be equal to half of a total quantity of

$$NZCs ⌈ \frac{{K}_{N Z}^{t o t}}{2} ⌉ ,$$

where the parameter K_{NZ}^{tot} indicates a total quantity of NZCs. The first half of the NZCs may be associated with highest priority NZCs and the first part of the NZC selection bits may be associated with the highest priority bits. Finally, group 2 may include a second half of the NZCs and a second part of the NZC selection bits.

In some examples, the CSI components associated with the highest priority group (e.g., group 0) may be omitted last and the CSI components associated with the lowest priority components may be omitted first. In such examples, an entire group, such as each CSI component associated with group 2, may be omitted during a process for omitting CSI components.

In some examples, coefficients (e.g., NZCs) and coefficient selection bits may be ordered based on a priority function (e.g., priority rule). In some such examples, the coefficients may be prioritized based on a layer-index l, followed by an SD basis index i, and an FD basis index m. Based on the priority, a first coefficient cᵢ_{₁}_{,m}_{₁}^{(l}^{₁}⁾ may have a lower priority than a second priority cᵢ_{₂}_{,m}_{₂}^{(l}^{₂}⁾ if Prio(l₁,i₁,m₁)>Prio(l₂,i₂,m₂), where Prio( ) represents the priority function. In some examples, Prio(l,i,m)=2L·RI·Perm(m)+RI·i+l, based on the priority order of layer-index l, followed by an SD basis index i, and an FD basis index m, where the parameter RI represents a rank indicator and L represents a quantity of beams. Additionally, Perm (m) maps the index m following the order of the corresponding FD components, if selected (0, N₃−1, 1, N₃−2, 2, . . . ). That is, coefficients closer to FD basis 0 are likely to be more significant.

Additionally, or alternatively, coefficients may be prioritized (e.g., ordered) from high to low based on the priority function and portioned into two groups. That is, a total quantity of coefficients (e.g., NZCs) K_{NZ}^{tot} may be divided into CSI omission groups in a predictable manner so that a quantity of coefficients in each CSI omission group is known prior to decoding CSI Part 2. The total quantity of coefficients K_{NZ}^{tot} may be indicated to the network node in CSI Part 1. For instance, the NZC coefficients may be divided between two CSI omission groups where coefficients associated with the first half of

$$⌈ \frac{{K}_{N Z}^{t o t}}{2} ⌉$$

of the NZCs and

$$( 2 L \cdot M \cdot RI - ⌊ \frac{{K}_{N Z}^{t o t}}{2} ⌋ )$$

bits for NZC selection may be associated with a first CSI omission group. Additionally, a second half of

$$⌊ \frac{{K}_{N Z}^{t o t}}{2} ⌋$$

of the NZCs and remaining

$$⌊ \frac{{K}_{N Z}^{t o t}}{2} ⌋$$

bits may be associated with a second CSI omission group. The first CSI omission group may be a high priority group and the second CSI omission group may be a low priority group. A non-zero PMI can be maintained if the second CSI omission group is omitted.

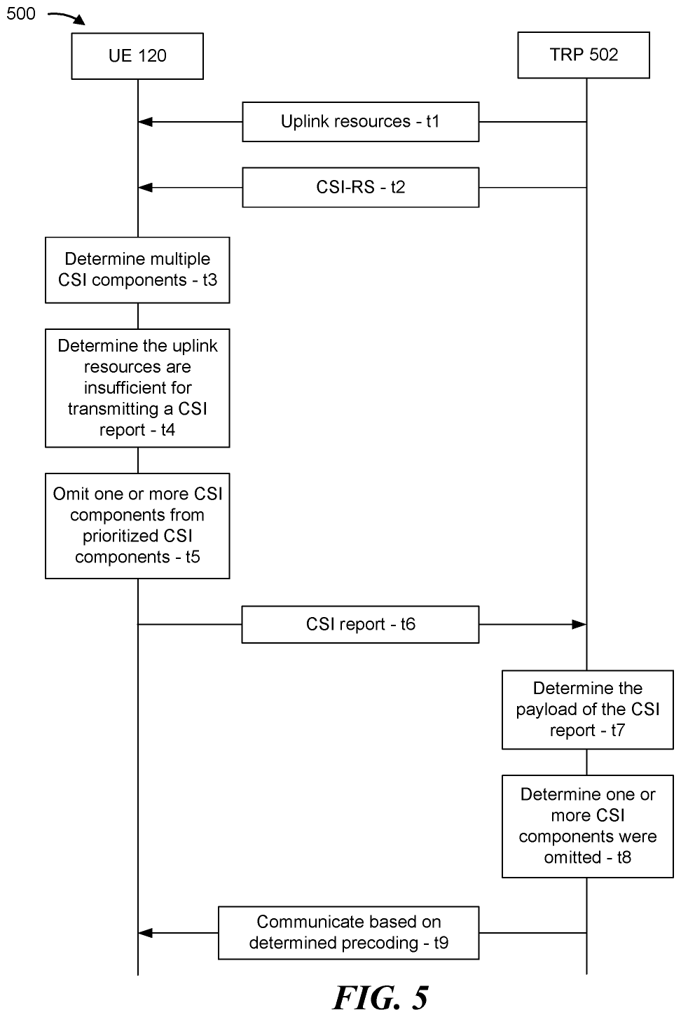

FIG. 5 is a timing diagram illustrating an example 500 of omitting one or more CSI components, in accordance with certain aspects of the present disclosure. The CSI components may also be referred to as CSI feedback components. In the example 500 of FIG. 5, a TRP 502 is one TRP of multiple TRPs associated with coherent joint transmissions to the UE 120. For ease of explanation, only one TRP 502 is shown. The TRP 502 may be an example of a base station 110 as described with reference to FIGS. 1 and 2, or a CU 310, a DU 330, or an RU 340 as described with reference to FIG. 3. As shown in FIG. 5, a time t1, the TRP 502 may signal, to the UE 120, one or more uplink resources to be used for CSI reporting. For example, the signal at time t1 may indicate (via radio resource control signaling) a CSI report configuration providing uplink resources for CSI reporting via the physical uplink control channel (PUCCH) and/or PUSCH. The CSI report configuration may provide uplink resources to use for transmitting the CSI report on an aperiodic, periodic, or semi-persistent basis. In the current example, the CSI report may be transmitted via the PUSCH.

In some examples, the signal at time t1 may also indicate a CSI resource configuration providing downlink (DL) resources associated with one or more CSI-RSs for the UE 120 to monitor, for example, on an aperiodic, periodic, or semi-persistent basis. For example, as the UE 120 is monitoring the downlink resources, the UE 120 may receive, from the TRP 502 at time t2, a CSI-RS associated with the downlink resources indicated at time t1. The UE 120 may determine, at time t3, multiple CSI components based on receiving the CSI-RS. The multiple CSI components may include one or more spatial beams, one or more compression bases associated with the one or more spatial beams (e.g., FD basis and SD basis), and one or more coefficients, such as NZCs, associated with the one or more spatial beams and one or more compression bases. In some examples, the UE 120 may also determine a TRP index.

At time t4, the UE 120 may determine that the uplink resources for transmitting the CSI report are insufficient for transmitting the CSI report (e.g., Part 2 CSI report). For example, the size of the CSI report may exceed the payload size for transmitting the Part 2 CSI report of the eType II CSI report. At time t5, the UE 120 may omit one or more CSI components from prioritized CSI components associated with the CSI report based on determining the uplink resources are insufficient for the Part 2 CSI report. In some examples, the CSI components may be prioritized based on a TRP priority rule. At time t6, the UE 120 may transmit, to the TRP 502, a CSI report that includes the remaining feedback components after the omission via the uplink resources signaled at time t1.

At time t7, the TRP 502 may determine the payload of the CSI report. For example, the TRP 502 may determine, from Part 1 of the CSI report, a payload of Part 2 of the CSI report. At time t8, the TRP 502 may determine that the allocated uplink resource were insufficient to carry the payload of Part 2 of the CSI report. Based on the determination at time t8, the TRP 502 may determine that one or more CSI components were omitted from the CSI report (e.g., Part 2 of the CSI report). For example, the TRP 502 may determine that one or more NZCs and NZC selection bits were omitted. The TRP 502 may determine a precoding for communicating with the UE 120 taking into account the omitted CSI components (e.g., taking into account CSI components remaining in the CSI report). At time t9, the TRP 502 may communicate with the UE 120 based on the determined precoding.

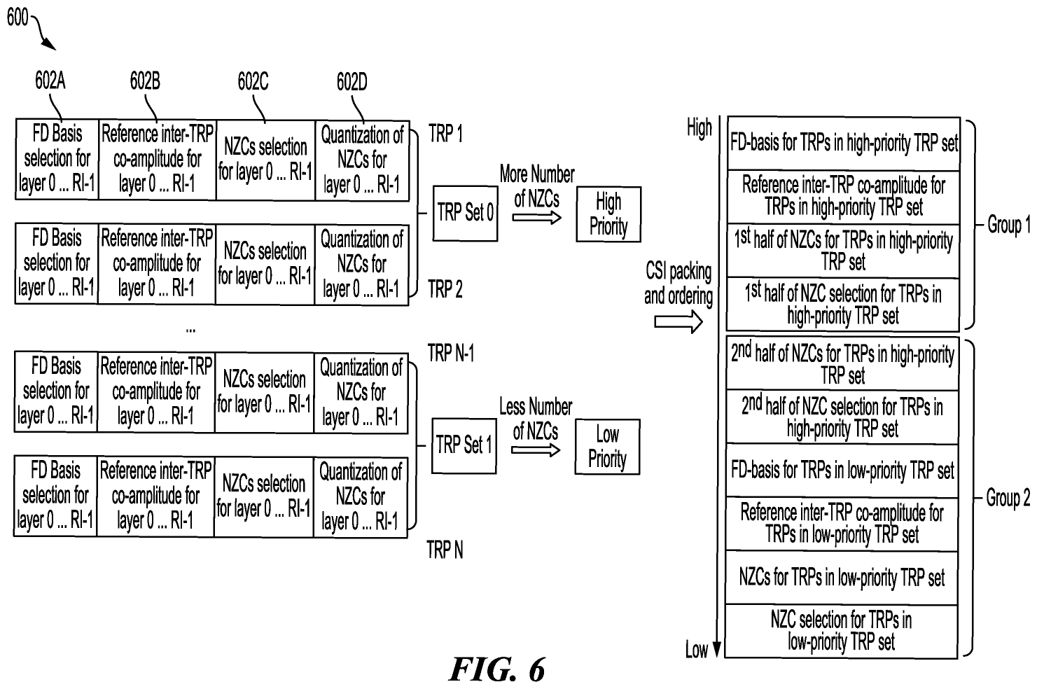

As discussed, a UE may prioritize CSI components associated with a CSI report based on a TRP priority rule. In some examples, the UE may group TRPs into two TRP sets, where each TRP set has the same quantity of TRPs. FIG. 6 is a block diagram illustrating an example 600 of TRP sets, in accordance with aspects of the present disclosure. As shown in FIG. 6, TRP 1 and TRP 2 may be grouped into a first TRP set (shown as TRP Set 0), and TRP N−1 and TRP N may be grouped into a second TRP set (shown as TRP Set 1). Each TRP may be associated with multiple CSI components 602A, 602B, 602C, 602D. As an example, the CSI components may include an FD basis 602A, a reference inter-TRP co-amplitude 602B, NZC selection bits 602C, and quantization of NZCs 602D. Each CSI component 602A, 602B, 602C, 602D may be associated with a layer index and a rank index. Aspects of the present disclosure are not limited to the CSI component 602A, 602B, 602C, 602D shown in FIG. 6. Additional CSI components may be associated with each TRP. In some examples, the TRP grouping may be predetermined based on the configuration received at the UE. Alternatively, the TRP grouping may be reported by the UE in Part 2 of the CSI report. In case of an odd number of TRPs, the non-reference TRPs may be grouped into two sets. The strongest reference TRP may be associated with a high priority TRP set and may be omitted last.

After grouping each TRP into a TRP set, the UE may determine a total quantity of non-zero coefficients (NZCs) in each TRP set. For example, the UE may determine a total quantity of NZCs in the first TRP set K_{NZ,Set0}^{tot} and a total quantity of NZCs in the second TRP set K_{NZ,Set1}^{tot}. In some examples, a total quantity of NZCs within the two TRP sets K_{NZ}^{tot} is the sum of a total quantity of NZCs in the first TRP set K_{NZ,Set0}^{tot} and a total quantity of NZCs in the second TRP set K_{NZ,Set1}^{tot}. In some examples, the total quantity of NZCs within the two TRP sets K_{NZ}^{tot} is reported in CSI Part 1. In some examples, if the total quantity of NZCs in the second TRP set K_{NZ,Set1}^{tot} is less than a total quantity of NZCs in the first TRP set K_{NZ,Set0}^{tot}, then the second TRP set is omitted first. Otherwise, the first TRP set is omitted first, that is, f K_{NZ,Set1}^{tot}<└K_{NZ}^{tot}/2┘, where K_{NZ}=K_{NZ,Set0}^{tot}+K_{NZ,Set1}^{tot}. More specifically, the TRP set with a higher quantity of NZCs may be more significant and may be omitted last. In the example 600 of FIG. 6, the first TRP set is associated with a greater quantity of NZCs than the quantity of NZCs associated with the second TRP set. Therefore, the first TRP is assigned a high priority and the second TRP is assigned a low priority.

After assigning a priority to each TRP set, the CSI components associated with the CSI report may be packed and ordered based on a TRP priority rule. That is, one or more first CSI components from the CSI components associated with the CSI report may be assigned to a high priority group, and one or more second CSI components from the CSI components associated with the CSI report may be assigned to a low priority group. Based on the example of FIG. 6, the one or more first CSI components may be associated with the first TRP set of the two TRP sets, and the one or more second CSI components may be associated with the first TRP set and a second TRP set of the two TRP sets.

As shown in FIG. 6, the groups are prioritized in descending order and include a high priority group (shown as group 1) and a low priority group (shown as group 2). Although not shown in FIG. 6, a highest priority group (group 0) may include an SD basis and SCI, similar to group 0 shown in FIG. 4. As discussed, one or more first CSI components from the CSI components associated with the CSI report may be assigned to the high priority group, and one or more second CSI components from the CSI components associated with the CSI report may be assigned to the low priority group. In the example 600 of FIG. 6, the one or more first CSI components include a frequency domain (FD) basis associated with TRPs in the first TRP set, a reference inter-TRP co-amplitude associated with TRPs in the first TRP set, a first half of non-zero coefficients (NZCs) associated with the first TRP set, and a first half of NZC selection bits associated with the first TRP. Additionally, the one or more second CSI components include a second half of NZCs associated with the first TRP set, a second half of NZC selection bits associated with the first TRP set, an FD basis for TRPs in the second TRP set, a reference inter-TRP co-amplitude associated with TRPs in the second TRP set, NZCs associated with the second TRP set, and/or NZC selection bits associated with the second TRP set to a low priority group. In the example 600 of FIG. 6, the NZC associated with the high priority TRP set include a first half and a second half. In this example, the first half includes

$$⌈ \frac{{K}_{N Z}^{t o t}}{2} ⌉$$

highest priority NZCs and the second half includes the remaining

$${K}_{NZ , {Set}_{j}}^{tot} - ⌈ \frac{{K}_{N Z}^{t o t}}{2} ⌉$$

highest priority NZCs, where K_{NZ, Set}_{ⱼ}^{tot} is a total quantity of NZCs in high priority TRP set (e.g., first TRP set). In some examples, each group (e.g., high priority group and low priority group) includes half, or approximately half, a total quantity of the NZCs. That is, a first quantity of

$$⌊ \frac{{K}_{N Z}^{t o t}}{2} ⌋$$

NZCs in the high priority group may be equal to half of a total quantity of in the NZCs, also a second quantity of NZCs in the low priority group may be equal to half of the total quantity of

$$NZCs ⌊ \frac{{K}_{N Z}^{t o t}}{2} ⌋$$

in the NZCs. Additionally, the NZC selection bits for the high priority TRP set include a first half and a second half. In this example, the first half includes

$$2 L \cdot M \cdot RI \cdot ⌈ \frac{{N}_{T R P}}{2} ⌉ - ⌊ \frac{{K}_{N Z}^{t o t}}{2} ⌋$$

highest priority bits and the second half includes

$$⌊ \frac{{K}_{N Z}^{t o t}}{2} ⌋$$

lowest priority bits. Finally, in the example 600 of FIG. 6, each CSI component associated with the low priority group may be omitted prior to omitting each CSI component of the high priority group. In some examples, an entire group, such as the low priority group, may be omitted.

In some implementations, the UE may assign one or more of the CSI components associated with the CSI report to a high priority group and a low priority group without grouping the TRPs into two TRP sets. In such implementations, the UE may assign one or more first CSI components from the multiple CSI components to the high priority group and also assign one or more second CSI components from the multiple CSI components to the low priority group. In some examples, the one or more first CSI components may include a frequency domain (FD) basis associated with the TRPs and corresponding layers, a reference inter-TRP co-amplitude associated with the TRPs and the corresponding layers, highest priority non-zero coefficients (NZCs) associated with the TRPs and the corresponding layers, and/or highest priority NZC selection bits associated with the TRPs and the corresponding layers. Additionally, the one or more second CSI components may include lowest priority NZCs associated with the TRPs and the corresponding layers, and/or lowest priority NZC selection bits associated with the TRPs and the corresponding layers. Similar to the example 600 of FIG. 6, each CSI component of the low priority group may be omitted prior to omitting each CSI component of the high priority group. In some examples, an entire group, such as the low priority group, may be omitted.

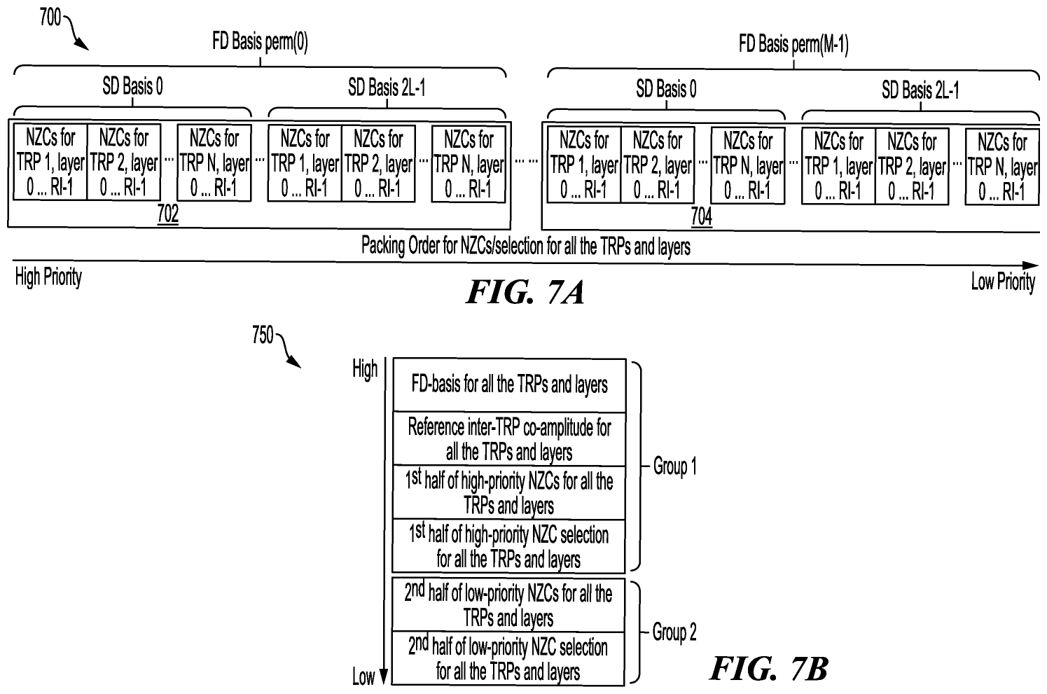

In other implementations, the TRP priority rule may prioritize multiple NZCs associated with the multiple CSI components of the CSI report. FIG. 7A is a block diagram illustrating an example 700 of prioritizing NZCs, in accordance with various aspects of the present disclosure. As shown in the example 700 of FIG. 7A, a UE, such as the UE 120 described with reference to FIGS. 1, 2, 3, and 5, may assign a first set of NZCs 702 of the multiple NZCs to a high priority group based on a priority associated with each NZC of the first set of NZCs. The UE may also assign a second set of NZCs 704 of the multiple NZCs to a low priority group based on a priority associated with each NZC of the second set of NZCs.

In the examples of FIG. 7A, the multiple NZCs may be prioritized based on a layer index I for each of the NZCs, followed in order by a TRP index p for each of the NZCs, a spatial domain (SD) basis index i associated with each of the NZCs, and a frequency domain (FD) basis index m associated with each of the NZCs. In this example, the priority function Prio( ) may be defined as Prio(l,p,i,m)=2L·N_{TRP}·RI·Perm (m)+N_{TRP}·RI·i+RI·g(p)+l, where the parameter N_{TRP} represents a quantity of TRPs associated with the coherent joint transmissions (CJTs) and the parameter g(p) represents a permutation function for a TRP index p. The function Perm(m) is a permutation function for the FD basis. In some examples, g(p)=p, such that a TRP priority level may be based on a configured TRP index. In other examples, g(p) maps the TRP index p based on the power of an associated TRP (e.g., g(i)≤g(j) if P_{TRP,i}≥P_{TRP,j}). In some such examples, the TRP power may be based on the reference power of inter-TRP co-amplitude. In other such examples, the TRP power may be based on both the reference power of the inter-TRP co-amplitude and the reference power for weaker polarization, assuming two polarizations of the TRP have a different reference power. Based on the priority function, a first coefficient cₚ_{₁}_{,i}_{₁}_{,m}_{₁}^{(l}^{₁}⁾ has a lower priority than a second coefficient cₚ_{₂}_{,i}_{₂}_{,m}_{₂}^{(l}^{₂}⁾ if Prio(l₁,p₁,l₁,m₁)>Prio(l₂,p₂,l₂,m₂).

In the example 700 of FIG. 7A, based on the priority function Prio(l,p,i,m), the multiple NZCs may be prioritized into two different sets 702, 704 that are distinguished based on an FD basis associated with each set 702, 704 (shown as FD basis perm(0) and FD basis perm(M−1), where FD basis perm(0) is a highest priority group and FD basis perm(M−1) is a lowest priority group). Within each set 702, 704, the NZCs may be further grouped based on an associated SD basis (shown as SD basis 0 and SD basis 2L−1). Finally, within each SD basis group, the NZCs may be prioritized based on a layer index l and a TRP index p. In the example 700 of FIG. 7A, the NZCs are associated with layer 0, therefore, the NZCs are prioritized in ascending order from TRP 1 to TRP N. Aspects of the present disclosure are not limited to the number of sets 702, 704 shown in FIG. 7A. Additional sets may be specified based on a quantity of the FD basis and/or a quantity of the SD basis. In the example 700 of FIG. 7A, one or more NZCs associated with the low priority group may be omitted prior to omitting one or more NZCs associated with the high priority group.

In other implementations, the NZCs may be prioritized based on a layer index l associated with each of the NZCs, followed in order by a spatial domain (SD) basis index i associated with each of the NZCs, a TRP index p associated with each of the NZCs, and a frequency domain (FD) basis index m associated with each of the NZCs. In such implementations, the priority function may be defined as Prio(l,i,p,m)=2L·N_{TRP}·RI·Perm (m)+N_{TRP}·RI·g(p)+RI·i+l.

After prioritizing the NZCs, the prioritized NZCs may be grouped into a high priority group and a low priority group. FIG. 7B is a block diagram illustrating an example 750 of grouping NZCs based on a priority level, in accordance with aspects of the present disclosure. In the example 700 of FIG. 7B, the high priority group (shown as Group 1) may include an FD basis associated with the TRPs and corresponding layers, a reference inter-TRP co-amplitude associated with the TRPs and the corresponding layers, highest priority NZCs associated with the TRPs and the corresponding layers, and highest priority NZC selection bits associated with the TRPs and the corresponding layers. Additionally, the low priority group (shown as Group 2) may include lowest priority NZCs associated with the TRPs and the corresponding layers, and lowest priority NZC selection bits associated with the TRPs and the corresponding layers. In some examples, each group (e.g., high priority group and low priority group) includes half, or approximately half, a total quantity of the NZCs. That is, a first quantity of NZCs in the high priority group may be equal to half of a total quantity of

$$NZCs ⌊ \frac{{K}_{N Z}^{t o t}}{2} ⌋$$

in the NZCs, also a second quantity of NZCs in the low priority group may be equal to half of the total quantity of

$$NZCs ⌊ \frac{{K}_{N Z}^{t o t}}{2} ⌋$$

in the NZCs.

FIG. 8 is a flow diagram illustrating an example process 800 performed, for example, by a user equipment (UE), in accordance with various aspects of the present disclosure. The example process 800 is an example of omitting one or more CSI components. The process 800 may be performed by a UE, such as the UE 120 described with reference to FIGS. 1, 2, 3, and 5. As shown in FIG. 8, the process 800 begins at block 802 by receiving a message scheduling a PUSCH. At block 804, the process 800 determines that a quantity of resources allocated for CSI reporting via the PUSCH is insufficient for transmitting a CSI report for a CJT associated with a group of TRPs, each TRP of the group of TRPs associated with a set of CSI components from a number of CSI components of the CSI report. At block 806, the process 800 prioritizes the group of CSI components based on a TRP priority rule. At block 808, the process 800 omits one or more CSI components from the prioritized group of CSI components based on determining the quantity of resources is insufficient. At block 810, the process 800 transmits, to one or more TRPs, the CSI report comprising remaining CSI components of the group of CSI components based on omitting the one or more CSI components.

FIG. 9 is a flow diagram illustrating an example process 900 performed, for example, by a network device, in accordance with various aspects of the present disclosure. The example process 900 is an example of determining precoding based on remaining CSI components in a CSI report. The process 900 may be performed by a network node, such as a TRP 502 described with reference to FIG. 6, a base station 110 as described with reference to FIGS. 1 and 2, or a CU 310, a DU 330, or an RU 340 as described with reference to FIG. 3. As shown in FIG. 9, the process 900 begins at block 902 by transmitting a message scheduling a PUSCH. At block 904, the process 900 transmits one or more CSI-RSs for a CJT associated with a group of TRPs, the network node is one TRP of the group of TRPs. At block 906, the process 900 receives, from a UE, a CSI report based on transmitting the one or more CSI-RSs, each TRP of the group of TRPs associated with a set of CSI components from a group of CSI components of the CSI report. At block 908, the process 900 determines that a quantity of resources allocated for CSI reporting via the PUSCH was insufficient for the CSI report. At block 910, the process 900 determines one or more CSI components from a prioritized group of CSI components were omitted from the CSI report based on determining the quantity of resources was insufficient, the group of CSI components being prioritized based on a TRP priority rule. At block 912, the process 900 transmits a precoded message based on determining the one or more CSI components were omitted from the prioritized group of CSI components, the precoding being determined based on CSI components remaining in the CSI report.

Implementation examples are described in the following numbered clauses:

Clause 1. A method for wireless communication by a user equipment (UE), comprising: receiving a message scheduling a physical uplink shared channel (PUSCH); determining that a quantity of resources allocated for channel state information (CSI) reporting via the PUSCH is insufficient for transmitting a CSI report for a coherent joint transmission (CJT) associated with a group of transmit and receive points (TRPs), each TRP of the group of TRPs associated with a set of CSI components from a group of CSI components of the CSI report; prioritizing the group of CSI components based on a TRP priority rule; omitting one or more CSI components from the prioritized group of CSI components based on determining the quantity of resources is insufficient; and transmitting, to one or more TRPs, the CSI report comprising remaining CSI components of the group of CSI components based on omitting the one or more CSI components.

Clause 2. The method of Clause 1, in which: prioritizing the group of CSI components based on the TRP priority rule comprises: assigning one or more first CSI components from the group of CSI components to a high priority group; and assigning one or more second CSI components from the group of CSI components to a low priority group; and omitting the one or more CSI components comprises omitting each CSI component of the low priority group prior to omitting each CSI component of the high priority group.

Clause 3. The method of Clause 2, further comprising: grouping the group of TRPs into two TRP sets, each TRP set having a same number of TRPs; and determining a total quantity of non-zero coefficients (NZCs) in each TRP set, in which: the one or more first CSI components are associated with a first TRP set of the two TRP sets; the one or more second CSI components are associated with the first TRP set and a second TRP set of the two TRP sets; and the first TRP set is associated with a greater quantity of NZCs in comparison to a quantity of NZCs associated with the second TRP set.

Clause 4. The method of Clause 3, in which: the one or more first CSI components comprise a first frequency domain (FD) basis for TRPs in the first TRP set, a first reference inter-TRP co-amplitude for TRPs in the first TRP set, a first half of non-zero coefficients (NZCs) associated with the first TRP set, and/or a first half of NZC selection bits associated with the first TRP set; and the one or more second CSI components comprise a second half of NZCs associated with the first TRP set, a second half of NZC selection bits associated with the first TRP set, a second FD basis for TRPs in the second TRP set, a second reference inter-TRP co-amplitude for TRPs in the second TRP set, NZCs associated with the second TRP set, and/or NZC selection bits associated with the second TRP set.

Clause 5. The method of Clause 2, in which: the one or more first CSI components comprise a frequency domain (FD) basis for the group of TRPs and corresponding layers, a reference inter-TRP co-amplitude for the group of TRPs and the corresponding layers, highest priority non-zero coefficients (NZCs) associated with the group of TRPs and the corresponding layers, and/or highest priority NZC selection bits associated with the group of TRPs and the corresponding layers; and the one or more second CSI components comprise lowest priority NZCs associated with the group of TRPs and the corresponding layers, and/or lowest priority NZC selection bits associated with the group of TRPs and the corresponding layers.

Clause 6. The method of Clause 1, in which omitting the one or more CSI components comprises omitting one or more non-zero coefficients (NZCs) of a low priority group prior to omitting the one or more NZCs of a high priority group.

Clause 7. The method of Clause 6, in which: prioritizing the group of CSI components based on the TRP priority rule comprises prioritizing a group of NZCs associated with the group of CSI components; a first set of NZCs of the group of NZCs are in the high priority group based on a priority associated with each NZC of the first set of NZCs; and a second set of NZCs of the group of NZCs are in the low priority group based on a priority associated with each NZC of the second set of NZCs.

Clause 8. The method of Clause 7, in which: a first quantity of NZCs in the first set of NZCs is equal to half of a total quantity of NZCs in the group of NZCs; and a second quantity of NZCs in the second set of NZCs is equal to half of the total quantity of NZCs in the group of NZCs.

Clause 9. The method of Clause 7, in which the group of NZCs are prioritized based on a layer index for each of the group of NZCs, followed in order by a TRP index for each of the group of NZCs, a spatial domain (SD) basis index for each of the group of NZCs, and a frequency domain (FD) basis index for each of the group of NZCs.

Clause 10. The method of Clause 7, in which the group of NZCs are prioritized based on a layer index for each of the group of NZCs, followed in order by a spatial domain (SD) basis index for each of the group of NZCs, a TRP index for each of the group of NZCs, and a frequency domain (FD) basis index for each of the group of NZCs.

Clause 11. A UE comprising a processor, memory coupled with the processor, and instructions stored in the memory and operable, when executed by the processor to cause the UE to perform any one of Clauses 1 through 10.

Clause 12. An apparatus configured for wireless communications comprising at least one means for performing any one of Clauses 1 through 10.

Clause 13. A computer program comprising code for causing an apparatus to perform any one of Clauses 1 through 10.

Clause 14. A method for wireless communication by a network node, comprising: transmitting a message scheduling a physical uplink shared channel (PUSCH); transmitting one or more channel state information-reference signals (CSI-RSs) associated with a coherent joint transmission (CJT) for a group of transmit and receive points (TRPs), the network node is one TRP of the group of TRPs; receiving, from a user equipment (UE), a CSI report based on transmitting the one or more CSI-RSs, each TRP of the group of TRPs associated with a set of CSI components from a group of CSI components of the CSI report; determining that a quantity of resources allocated for CSI reporting via the PUSCH was insufficient for the CSI report; determining one or more CSI components from a prioritized group of CSI components were omitted from the CSI report based on determining the quantity of resources was insufficient, the group of CSI components being prioritized based on a TRP priority rule; and transmitting a precoded message based on determining the one or more CSI components were omitted from the prioritized group of CSI components, the precoding being determined based on CSI components remaining in the CSI report.

Clause 15. The method of Clause 14, in which: the prioritized group of CSI components comprise: a high priority group comprising one or more first CSI components from the group of CSI components; and a low priority group comprising one or more second CSI components from the group of CSI components; and each CSI component of the low priority group is omitted prior to each CSI component of the high priority group.

Clause 16. The method of Clause 15, in which: the one or more first CSI components are associated with a first TRP set of the two TRP sets; the one or more second CSI components are associated with the first TRP set and a second TRP set of the two TRP sets; and the first TRP set is associated with a greater quantity of non-zero coefficients (NZCs) in comparison to a quantity of NZCs associated with the second TRP set.

Clause 17. The method of Clause 16, in which: the one or more first CSI components comprise a first frequency domain (FD) basis for TRPs in the first TRP set, a first reference inter-TRP co-amplitude for TRPs in the first TRP set, a first half of non-zero coefficients (NZCs) associated with the first TRP set, and/or a first half of NZC selection bits associated with the first TRP set; and the one or more second CSI components comprise a second half of NZCs associated with the first TRP set, a second half of NZC selection bits associated with the first TRP set, a second FD basis for TRPs in the second TRP set, a second reference inter-TRP co-amplitude for TRPs in the second TRP set, NZCs associated with the second TRP set, and/or NZC selection bits associated with the second TRP set.

Clause 18. The method of Clause 14, in which: the prioritized group of CSI components are associated with a group of NZCs; a first set of NZCs of the group of NZCs are in a high priority group based on a priority associated with each NZC of the first set of NZCs; a second set of NZCs of the group of NZCs are in a low priority group based on a priority associated with each NZC of the second set of NZCs; and the group of NZCs are prioritized based on a layer index for each of the group of NZCs, followed in order by a TRP index for each of the group of NZCs, a spatial domain (SD) basis index for each of the group of NZCs, and a frequency domain (FD) basis index for each of the group of NZCs.

Clause 19. A network node comprising a processor, memory coupled with the processor, and instructions stored in the memory and operable, when executed by the processor to cause the UE to perform any one of Clauses 14 through 18.

Clause 20. An apparatus configured for wireless communications comprising at least one means for performing any one of Clauses 14 through 18.

Clause 21. A computer program comprising code for causing an apparatus to perform any one of Clauses 14 through 18.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication by a user equipment (UE), comprising:
receiving a message scheduling a physical uplink shared channel (PUSCH);
determining that a quantity of resources allocated for channel state information (CSI) reporting via the PUSCH is insufficient for transmitting a CSI report for a coherent joint transmission (CJT) associated with a plurality of transmit and receive points (TRPs), each TRP of the plurality of TRPs associated with a set of CSI components from a plurality of CSI components of the CSI report;
prioritizing the plurality of CSI components based on a TRP priority rule;
omitting one or more CSI components from the prioritized plurality of CSI components based on determining the quantity of resources is insufficient; and
transmitting, to one or more TRPs, the CSI report comprising remaining CSI components of the plurality of CSI components based on omitting the one or more CSI components.

2. The method of claim 1, in which:
prioritizing the plurality of CSI components based on the TRP priority rule comprises:
assigning one or more first CSI components from the plurality of CSI components to a high priority group; and
assigning one or more second CSI components from the plurality of CSI components to a low priority group; and
omitting the one or more CSI components comprises omitting each CSI component of the low priority group prior to omitting each CSI component of the high priority group.

3. The method of claim 2, further comprising:
grouping the plurality of TRPs into two TRP sets, each TRP set having a same number of TRPs; and
determining a total quantity of non-zero coefficients (NZCs) in each TRP set,
in which:
the one or more first CSI components are associated with a first TRP set of the two TRP sets;
the one or more second CSI components are associated with the first TRP set and a second TRP set of the two TRP sets; and
the first TRP set is associated with a greater quantity of NZCs in comparison to a quantity of NZCs associated with the second TRP set.

4. The method of claim 3, in which:
the one or more first CSI components comprise a first frequency domain (FD) basis for TRPs in the first TRP set, a first reference inter-TRP co-amplitude for TRPs in the first TRP set, a first half of non-zero coefficients (NZCs) associated with the first TRP set, and/or a first half of NZC selection bits associated with the first TRP set; and
the one or more second CSI components comprise a second half of NZCs associated with the first TRP set, a second half of NZC selection bits associated with the first TRP set, a second FD basis for TRPs in the second TRP set, a second reference inter-TRP co-amplitude for TRPs in the second TRP set, NZCs associated with the second TRP set, and/or NZC selection bits associated with the second TRP set.

5. The method of claim 2, in which:
the one or more first CSI components comprise a frequency domain (FD) basis for the plurality of TRPs and corresponding layers, a reference inter-TRP co-amplitude for the plurality of TRPs and the corresponding layers, highest priority non-zero coefficients (NZCs) associated with the plurality of TRPs and the corresponding layers, and/or highest priority NZC selection bits associated with the plurality of TRPs and the corresponding layers; and
the one or more second CSI components comprise lowest priority NZCs associated with the plurality of TRPs and the corresponding layers, and/or lowest priority NZC selection bits associated with the plurality of TRPs and the corresponding layers.

6. The method of claim 1, in which omitting the one or more CSI components comprises omitting one or more non-zero coefficients (NZCs) of a low priority group prior to omitting the one or more NZCs of a high priority group.

7. The method of claim 6, in which:
prioritizing the plurality of CSI components based on the TRP priority rule comprises prioritizing a plurality of NZCs associated with the plurality of CSI components;
a first set of NZCs of the plurality of NZCs are in the high priority group based on a priority associated with each NZC of the first set of NZCs; and
a second set of NZCs of the plurality of NZCs are in the low priority group based on a priority associated with each NZC of the second set of NZCs.

8. The method of claim 7, in which:
a first quantity of NZCs in the first set of NZCs is equal to half of a total quantity of NZCs in the plurality of NZCs; and
a second quantity of NZCs in the second set of NZCs is equal to half of the total quantity of NZCs in the plurality of NZCs.

9. The method of claim 7, in which the plurality of NZCs are prioritized based on a layer index for each of the plurality of NZCs, followed in order by a TRP index for each of the plurality of NZCs, a spatial domain (SD) basis index for each of the plurality of NZCs, and a frequency domain (FD) basis index for each of the plurality of NZCs.

10. The method of claim 7, in which the plurality of NZCs are prioritized based on a layer index for each of the plurality of NZCs, followed in order by a spatial domain (SD) basis index for each of the plurality of NZCs, a TRP index for each of the plurality of NZCs, and a frequency domain (FD) basis index for each of the plurality of NZCs.

11. An apparatus for wireless communications at a user equipment (UE), comprising:
a processor; and
a memory coupled with the processor and storing instructions operable, when executed by the processor, to cause the apparatus to:
receive a message scheduling a physical uplink shared channel (PUSCH);
determine that a quantity of resources allocated for channel state information (CSI) reporting via the PUSCH is insufficient for transmitting a CSI report for a coherent joint transmission (CJT) associated with a plurality of transmit and receive points (TRPs), each TRP of the plurality of TRPs associated with a set of CSI components from a plurality of CSI components of the CSI report;
prioritize the plurality of CSI components based on a TRP priority rule;
omit one or more CSI components from the prioritized plurality of CSI components based on determining the quantity of resources is insufficient; and
transmit, to one or more TRPs, the CSI report comprising remaining CSI components of the plurality of CSI components based on omitting the one or more CSI components.

12. The apparatus of claim 11, in which:
execution of the instructions that cause the apparatus to prioritize the plurality of CSI components based on the TRP priority rule further cause the apparatus to:
assign one or more first CSI components from the plurality of CSI components to a high priority group; and
assign one or more second CSI components from the plurality of CSI components to a low priority group; and
execution of the instructions further cause the apparatus to omit the one or more CSI components comprises omitting each CSI component of the low priority group prior to omitting each CSI component of the high priority group.

13. The apparatus of claim 12, in which:
execution of the instructions further cause the apparatus to:
group the plurality of TRPs into two TRP sets, each TRP set having a same number of TRPs; and
determine a total quantity of non-zero coefficients (NZCs) in each TRP set;
the one or more first CSI components are associated with a first TRP set of the two TRP sets;
the one or more second CSI components are associated with the first TRP set and a second TRP set of the two TRP sets; and
the first TRP set is associated with a greater quantity of NZCs in comparison to a quantity of NZCs associated with the second TRP set.

14. The apparatus of claim 13, in which:
the one or more first CSI components comprise a first frequency domain (FD) basis for TRPs in the first TRP set, a first reference inter-TRP co-amplitude for TRPs in the first TRP set, a first half of non-zero coefficients (NZCs) associated with the first TRP set, and/or a first half of NZC selection bits associated with the first TRP set; and
the one or more second CSI components comprise a second half of NZCs associated with the first TRP set, a second half of NZC selection bits associated with the first TRP set, a second FD basis for TRPs in the second TRP set, a second reference inter-TRP co-amplitude for TRPs in the second TRP set, NZCs associated with the second TRP set, and/or NZC selection bits associated with the second TRP set.

15. The apparatus of claim 12, in which:
the one or more first CSI components comprise a frequency domain (FD) basis for the plurality of TRPs and corresponding layers, a reference inter-TRP co-amplitude for the plurality of TRPs and the corresponding layers, highest priority non-zero coefficients (NZCs) associated with the plurality of TRPs and the corresponding layers, and/or highest priority NZC selection bits associated with the plurality of TRPs and the corresponding layers; and
the one or more second CSI components comprise lowest priority NZCs associated with the plurality of TRPs and the corresponding layers, and/or lowest priority NZC selection bits associated with the plurality of TRPs and the corresponding layers.

16. The apparatus of claim 11, in which execution of the instructions that cause the apparatus to omit the one or more CSI components further cause the apparatus to omit one or more non-zero coefficients (NZCs) of a low priority group prior to omitting the one or more NZCs of a high priority group.

17. The apparatus of claim 16, in which:
execution of the instructions further cause the apparatus to prioritize the plurality of CSI components based on the TRP priority rule further cause the apparatus to prioritize a plurality of NZCs associated with the plurality of CSI components;
a first set of NZCs of the plurality of NZCs are in the high priority group based on a priority associated with each NZC of the first set of NZCs; and
a second set of NZCs of the plurality of NZCs are in the low priority group based on a priority associated with each NZC of the second set of NZCs.

18. The apparatus of claim 17, in which:
a first quantity of NZCs in the first set of NZCs is equal to half of a total quantity of NZCs in the plurality of NZCs; and
a second quantity of NZCs in the second set of NZCs is equal to half of the total quantity of NZCs in the plurality of NZCs.

19. The apparatus of claim 17, in which the plurality of NZCs are prioritized based on a layer index for each of the plurality of NZCs, followed in order by a TRP index for each of the plurality of NZCs, a spatial domain (SD) basis index for each of the plurality of NZCs, and a frequency domain (FD) basis index for each of the plurality of NZCs.

20. The apparatus of claim 17, in which the plurality of NZCs are prioritized based on a layer index for each of the plurality of NZCs, followed in order by a spatial domain (SD) basis index for each of the plurality of NZCs, a TRP index for each of the plurality of NZCs, and a frequency domain (FD) basis index for each of the plurality of NZCs.

21. A method for wireless communication by a network node, comprising:
transmitting a message scheduling a physical uplink shared channel (PUSCH);
transmitting one or more channel state information-reference signals (CSI-RSs) for a coherent joint transmission (CJT) associated with a plurality of transmit and receive points (TRPs), the network node is one TRP of the plurality of TRPs;
receiving, from a user equipment (UE), a CSI report based on transmitting the one or more CSI-RSs, each TRP of the plurality of TRPs associated with a set of CSI components from a plurality of CSI components of the CSI report;
determining that a quantity of resources allocated for CSI reporting via the PUSCH was insufficient for the CSI report;
determining one or more CSI components from a prioritized plurality of CSI components were omitted from the CSI report based on determining the quantity of resources was insufficient, the plurality of CSI components being prioritized based on a TRP priority rule; and
transmitting a precoded message based on determining the one or more CSI components were omitted from the prioritized plurality of CSI components, the precoding being determined based on remaining CSI components.

22. The method of claim 21, in which:
the prioritized plurality of CSI components comprise:
a high priority group comprising one or more first CSI components from the plurality of CSI components; and
a low priority group comprising one or more second CSI components from the plurality of CSI components; and
each CSI component of the low priority group is omitted prior to each CSI component of the high priority group.

23. The method of claim 22, in which:
the one or more first CSI components are associated with a first TRP set of the two TRP sets;
the one or more second CSI components are associated with the first TRP set and a second TRP set of the two TRP sets; and
the first TRP set is associated with a greater quantity of non-zero coefficients (NZCs) in comparison to a quantity of NZCs associated with the second TRP set.

24. The method of claim 23, in which:
the one or more first CSI components comprise a first frequency domain (FD) basis for TRPs in the first TRP set, a first reference inter-TRP co-amplitude for TRPs in the first TRP set, a first half of non-zero coefficients (NZCs) associated with the first TRP set, and/or a first half of NZC selection bits associated with the first TRP set; and
the one or more second CSI components comprise a second half of NZCs associated with the first TRP set, a second half of NZC selection bits associated with the first TRP set, a second FD basis for TRPs in the second TRP set, a second reference inter-TRP co-amplitude for TRPs in the second TRP set, NZCs associated with the second TRP set, and/or NZC selection bits associated with the second TRP set.

25. The method of claim 21, in which:
the prioritized plurality of CSI components are associated with a plurality of NZCs;
a first set of NZCs of the plurality of NZCs are in a high priority group based on a priority associated with each NZC of the first set of NZCs;
a second set of NZCs of the plurality of NZCs are in a low priority group based on a priority associated with each NZC of the second set of NZCs; and
the plurality of NZCs are prioritized based on a layer index for each of the plurality of NZCs, followed in order by a TRP index for each of the plurality of NZCs, a spatial domain (SD) basis index for each of the plurality of NZCs, and a frequency domain (FD) basis index for each of the plurality of NZCs.

26. An apparatus for wireless communications at a network node, comprising:
a processor; and
a memory coupled with the processor and storing instructions operable, when executed by the processor, to cause the apparatus to:
transmit a message scheduling a physical uplink shared channel (PUSCH);
transmit one or more channel state information-reference signals (CSI-RSs) for a coherent joint transmission (CJT) associated with a plurality of transmit and receive points (TRPs), the network node is one TRP of the plurality of TRPs;
receive, from a user equipment (UE), a CSI report based on transmitting the one or more CSI-RSs, each TRP of the plurality of TRPs associated with a set of CSI components from a plurality of CSI components of the CSI report;
determine that a quantity of resources allocated for CSI reporting via the PUSCH was insufficient for the CSI report;
determine one or more CSI components from a prioritized plurality of CSI components were omitted from the CSI report based on determining the quantity of resources was insufficient, the plurality of CSI components being prioritized based on a TRP priority rule; and
transmit a precoded message based on determining the one or more CSI components were omitted from the prioritized plurality of CSI components, the precoding being determined based on remaining CSI components.

27. The apparatus of claim 26, in which:
the prioritized plurality of CSI components comprise:
a high priority group comprising one or more first CSI components from the plurality of CSI components; and
a low priority group comprising one or more second CSI components from the plurality of CSI components; and
each CSI component of the low priority group is omitted prior to each CSI component of the high priority group.

28. The apparatus of claim 27, in which:
the one or more first CSI components are associated with a first TRP set of the two TRP sets;
the one or more second CSI components are associated with the first TRP set and a second TRP set of the two TRP sets; and
the first TRP set is associated with a greater quantity of non-zero coefficients (NZCs) in comparison to a quantity of NZCs associated with the second TRP set.

29. The apparatus of claim 28, in which:
the one or more first CSI components comprise a first frequency domain (FD) basis for TRPs in the first TRP set, a first reference inter-TRP co-amplitude for TRPs in the first TRP set, a first half of non-zero coefficients (NZCs) associated with the first TRP set, and/or a first half of NZC selection bits associated with the first TRP set; and
the one or more second CSI components comprise a second half of NZCs associated with the first TRP set, a second half of NZC selection bits associated with the first TRP set, a second FD basis for TRPs in the second TRP set, a second reference inter-TRP co-amplitude for TRPs in the second TRP set, NZCs associated with the second TRP set, and/or NZC selection bits associated with the second TRP set.

30. The apparatus of claim 26, in which:
the prioritized plurality of CSI components are associated with a plurality of NZCs;
a first set of NZCs of the plurality of NZCs are in a high priority group based on a priority associated with each NZC of the first set of NZCs;
a second set of NZCs of the plurality of NZCs are in a low priority group based on a priority associated with each NZC of the second set of NZCs; and
the plurality of NZCs are prioritized based on a layer index for each of the plurality of NZCs, followed in order by a TRP index for each of the plurality of NZCs, a spatial domain (SD) basis index for each of the plurality of NZCs, and a frequency domain (FD) basis index for each of the plurality of NZCs.
